(19) United States
(12) Patent Application Publication
(10) Pub. No.: US 2025/0050736 A1
(43) Pub. Date: Feb. 13, 2025

(54) Method, Computer Program, Device and Vehicle for Displaying Supervisory Information in the Field of Vision of a Driver

(71) Applicant: Bayerische Motoren Werke Aktiengesellschaft, Muenchen (DE)

(72) Inventor: Jochen Pfannstiel, Muenchen (DE)

(21) Appl. No.: 18/712,193

(22) PCT Filed: Sep. 28, 2022
(86) PCT No.: PCT/EP2022/076902

§ 371 Date: May 21, 2024

(30) Foreign Application Priority Data
Dec. 8, 2021 (DE) 10 2021 132 270.7

(51) Int. Cl. B60K 35/28; B60K 35/22; B60K 35/65; G07C 5/08

(52) U.S. Cl. CPC B60K 35/285; B60K 35/22; B60K 35/654; G07C 5/0816; B60K 2360/161; B60K 2360/178; B60K 2360/1876

(57) ABSTRACT

A method displays supervisory information in the field of view of a driver of a vehicle. The method includes displaying two or more items of supervisory information in an arrangement of adjacent display fields. The method also includes displaying a temporal relationship between the occurrences of the two or more items of supervisory information via positions of the two or more items of supervisory information within the arrangement.

The present application is the U.S. national phase of PCT Application PCT/EP2022/076902 filed on Sep. 28, 2022, which claims priority of German patent application No. 102021132270.7 filed on Dec. 8, 2021, the entire contents of which are incorporated herein by reference.

### TECHNICAL FIELD

The present disclosure relates to the field of displaying supervisory information in the field of view of a driver.

### BACKGROUND

Malfunctions or problems with a vehicle often cannot be identified from the outside. For this reason, indicator lights have been integrated into vehicles. These are used to tell the vehicle driver about a problem a or malfunction on the vehicle or to warn them on a preventative basis. Instructions that for example refer to driving behavior, such as for example “stay in lane”, are additionally given. The color of the indicator light gives an indication as to whether a malfunction or an instruction is involved. Generally, the light from the indicator light stops shining when the problem has been rectified or the instruction has been acted upon. The indicator lights are usually arranged on the dashboard of the vehicle. By way of example, an individual indicator light is assigned a fixed spot at which only this indicator light is able to appear.

In modern vehicles in particular, there is a variety of different information that is presented to a driver of a vehicle in the form of check symbols, indicator lights, text, etc. As the number of individual items of information increases, the risk of a driver being distracted may increase. Moreover, the driver is accustomed to seeing certain supervisory information at certain locations in their field of view, and So traditionally specific indicator lights are assigned specific locations in the cockpit of vehicles. There is a tendency to make the display area ever larger or to display more and more information. This may be accompanied by the risk of there increasingly being a lack of clarity because the individual displays are becoming ever smaller or being arranged further apart. By way of example, as the number of indicator lights increases, the space that they require increases accordingly. Moreover, any association between text-based fault messages (“Check Controls”) and the corresponding indicator light may become less clear due to the distance between their locations.

There is therefore a need to provide an improved concept for displaying supervisory information in the field of view of a driver. The subjects of the attached independent claims take this need into consideration.

### SUMMARY

Exemplary embodiments are based on the finding that, in conventional display concepts, there is no information available about the order in which faults occur, and it is therefore not possible to derive a causality chain either. Moreover, freely usable display surfaces are available. Exemplary embodiments are based on the core concept that indicator lights are able to be displayed dynamically in a common area and are able to be moved around in relation to one another. The chronological sequence may decide the order in which they are displayed, such that this information is also able to be transmitted. By way of example, a driver always sees a first indicator light that occurs (regardless of which one it is) at the same expected location that has already been learned. Statistically, it is unlikely that all indicator lights will occur at the same time, for which reason a display surface after the first 2-3 indicator lights is generally able to be used freely for other displays such as a tachometer or the like. This gives rise to a kind of bundled gain, and, at least statistically speaking, the same number of indicator lights are able to be displayed on a smaller surface.

Exemplary embodiments provide a method for displaying supervisory information in the field of view of a driver of a vehicle. The method comprises displaying two or more items of supervisory information in an arrangement of adjacent display fields and displaying a temporal relationship between the occurrences of the two or more items of supervisory information via positions of the two or more items of supervisory information within the arrangement. Exemplary embodiments may thus enable a driver to read off the chronological order of occurrence of the respective events from the display.

In some exemplary embodiments, a newest item of supervisory information may also be displayed at one end of the arrangement and an oldest item of supervisory information may be displayed at another end of the arrangement. This allows the driver to see the temporal relevance of the respective supervisory information at first glance.

By way of example, the oldest or the newest item of supervisory information from the two or more items of supervisory information may be displayed always at the same absolute position in the field of view of the driver. This makes it possible to display the most recent or else the longest-persisting supervisory information always at the same location or always at the same place in the field of view of the driver.

In further exemplary embodiments, a display of supervisory information that is no longer relevant may be cleared from the arrangement. Accordingly, irrelevant supervisory information is also cleared again such that it is not able to distract a driver any further. Furthermore, at least in some exemplary embodiments, the method may comprise closing a gap in the arrangement that has arisen due to a display being cleared by dynamically moving the remaining supervisory information. This makes it possible to achieve an uninterrupted representation within the arrangement.

In some exemplary embodiments, the displayed supervisory information may also be built up over the adjacent display fields in succession in a direction predefined by the arrangement of the display fields. This makes it possible to achieve a kind of progress display that shows both the number and the order of the items of supervisory information in an easily graspable manner.

By way of example, supervisory information may be displayed by showing a graphic symbol typical of the supervisory information. This makes it possible to transmit the respective information to a driver with little effort using intuitively comprehensible graphic symbols.

In some exemplary embodiments, the supervisory information may comprise one or more elements from the group comprising a tire pressure warning signal, a warning signal from an anti-lock braking system, an airbag warning signal, an engine warning signal, a steering warning signal, a proximity warning signal, a performance warning signal, a battery warning signal and a handbrake warning signal. This makes it possible to display the number, the type and also the order/temporal relevance of supervisory information to a driver in an easily understandable manner.

Exemplary embodiments also provide a computer program for performing one of the methods described herein when the computer program runs on a computer, a processor or a programmable hardware component.

A further exemplary embodiment is a device for a vehicle, having a control unit that is designed to perform one of the methods described herein. Exemplary embodiments furthermore provide a vehicle having a device as described herein.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows a schematic illustration of one exemplary embodiment of a method for displaying supervisory information in the field of view of a driver of a vehicle;

FIG. 2 shows a block diagram of one exemplary embodiment of a device for a vehicle and one exemplary embodiment of a vehicle;

FIG. 3 shows an arrangement of display fields in one exemplary embodiment; and

FIG. 4 shows a schematic illustration relating to the buildup of a display of multiple items of supervisory information in one exemplary embodiment.

### DETAILED DESCRIPTION

Various exemplary embodiments will now be described in more detail with reference to the accompanying drawings, which show a few exemplary embodiments. In the figures, the thickness dimensions of lines, layers and/or regions may be depicted in exaggerated form for the sake of clarity. Optional features are shown using dashed lines.

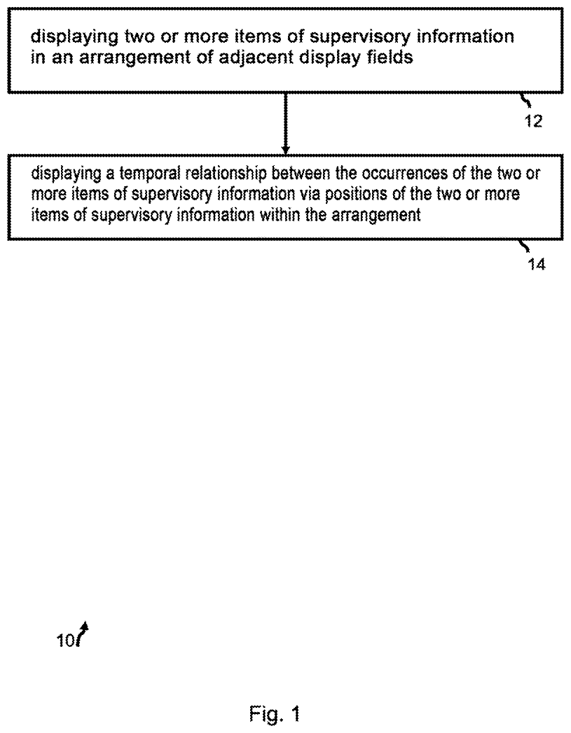

FIG. 1 shows a schematic illustration of one exemplary embodiment of a method 10 for displaying supervisory information in the field of view of a driver of a vehicle. The field of view of the driver usually contains the instruments and displays of the vehicle during operation. It is possible to use various displays for this purpose, such as for example a head-up display (projection onto/against the windscreen) or a display in general that may be installed in the dashboard or in the cockpit of the vehicle in the field of view of the driver. As FIG. 1 shows, the method comprises displaying 12 two or more items of supervisory information in an arrangement of adjacent display fields and displaying 14 a temporal relationship between the occurrences of the two or more items of supervisory information via positions of the two items of supervisory information within the arrangement. By way of example, a newest item of supervisory information may be displayed at one end of the arrangement and an oldest item of supervisory information may be displayed at another end of the arrangement. The arrangement may in this case extend along a predefined profile, such as for example a straight or curved profile. This then makes it possible to display a sequence of successive items of supervisory information along the arrangement.

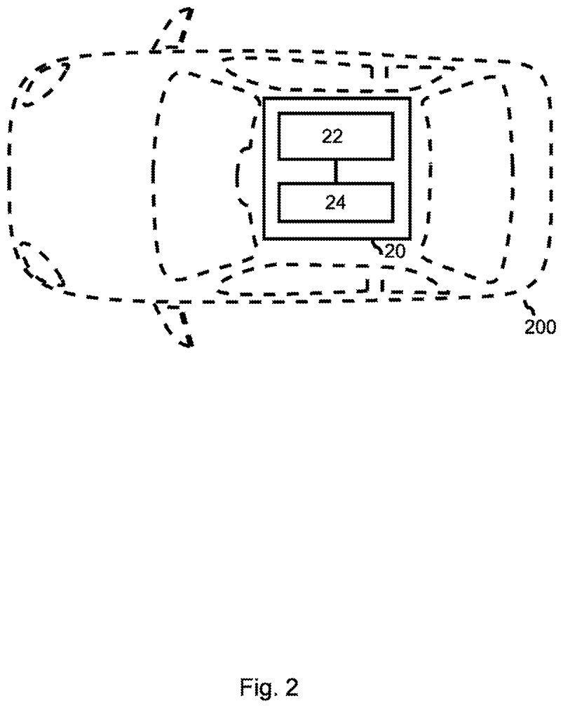

FIG. 2 illustrates a block diagram of one exemplary embodiment of a device 20 for a vehicle and one exemplary embodiment of a vehicle 200. The vehicle 200 is shown in dashed lines since it is optional from the point of view of the device 20. The device 20 for the vehicle 200 comprises a control unit 24 that is designed to perform one of the methods 10 described herein. The vehicle 200 comprises one exemplary embodiment of the device 20.

In some exemplary embodiments, the device 20 may comprise one or more interfaces 22 that are coupled to the control unit or the control module 24. The one or more interfaces 22 may for example correspond to one or more inputs and/or one or more outputs for receiving and/or transmitting information, for instance in digital binary values, based on a code, within a module, between modules, or between modules of different entities. The at least one interface 22 may for example be designed to communicate with other network components via a network or a local connection network and to communicate graphic outputs, such as text or graphic symbols, to a display, a screen or generally to a graphic output device.

In some exemplary embodiments, the control unit/control module 24 may correspond to any controller or processor or to a programmable hardware component. By way of example, the control module 24 may also be implemented in the form of software that is programmed for a corresponding hardware component. In this respect, the control module 24 may be implemented in the form of programmable hardware with software that is adapted accordingly. Any processors, such as digital signal processors (DSPs), may be used in this context. Exemplary embodiments are not restricted to a specific type of processor. Any processors or even multiple processors are conceivable for implementing the control module 24.

In at least some exemplary embodiments, the vehicle 200 may correspond for example to a land vehicle, a watercraft, an aircraft, a rail vehicle, a road vehicle, a car, a bus, a motorcycle, an all-terrain vehicle, a motor vehicle, or a truck.

In some exemplary embodiments, the supervisory information comprises for example indicator lights that provide the driver with various warning signals or instructions. The lights indicator are for example displayed dynamically in a region that is located in the field of view of the driver. In this regard, exemplary embodiments also provide a system that allows the lights (supervisory information) to appear in succession and move around dynamically in relation to one another. A freshly appearing light (information) may take up the spot next to (or else above) the light that appeared previously.

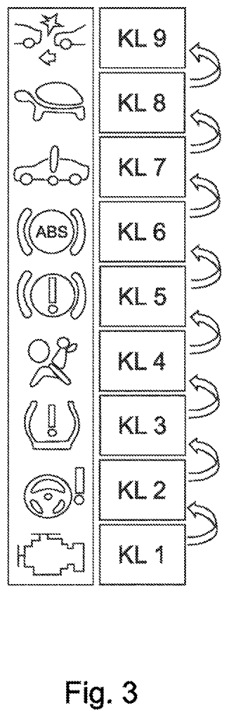

FIG. 3 shows an arrangement of display fields in one exemplary embodiment. FIG. 3 illustrates a system, by way of example, based on a vertical column with nine possible light-up fields. As an example, one column is chosen for nine indicator light symbols, having the display fields KL1, KL2, KL3, KL4, KL5, KL6, KL7, KL8 and KL9. In other exemplary embodiments, other geometries, in particular a row, an arc, a partial circle (semicircle) or a different directional curved profile, and a different number of display fields, are also conceivable.

In some exemplary embodiments, the method may comprise displaying supervisory information by showing a graphic symbol typical of the supervisory information, some examples of which are depicted in the subsequent figures. By way of example, the supervisory information may comprise one or more elements from the group comprising a tire pressure warning signal, a warning signal from an anti-lock braking system, an airbag warning signal, an engine warning signal, a steering warning signal, a proximity warning signal, a performance warning signal, a battery warning signal and a handbrake warning signal.

In the exemplary embodiment in FIG. 3, when there are no instructions/warnings, the column remains empty. The first light that appears is displayed for example in the bottom field in the column. If a second light is added, this light is displayed one field above. This procedure goes on until the ninth light appears. The column is then full; this state is shown in FIG. 3. In detail, the light that is displayed in the display field KL9 (proximity warning) in FIG. 3 was the latest/most recent supervisory information here and is displayed in KL9 because KL1 to KL8 were already occupied at the time when the proximity warning occurred. The oldest light is the engine warning, which is displayed in KL1. When the light that is displayed in KL2 (steering warning) in FIG. 3 subsequently occurred as the second light, KL1 was already occupied and this information was assigned the next display field KL2. This process was then repeated with the other indicator lights until, finally, all nine lights were displayed in a manner stacked above one another as shown in FIG. 3. The method 10 comprises building up the displayed supervisory information over the adjacent display fields in succession in a direction predefined by the arrangement of the display fields.

In this exemplary embodiment, the method 10 comprises displaying the oldest supervisory information from the two or more items of supervisory information always at the same absolute position in the field of view of the driver, namely at the bottom in the column. In other exemplary embodiments, other variants are also conceivable, for example the oldest information is displayed at the top or the order is governed by the newest information (which is then always displayed at the bottom or at the top).

In a further exemplary embodiment, lights may also be moved if other lights are cleared, for example because the information associated therewith has been dealt with. The method 10 then comprises clearing a display of supervisory information that is no longer relevant from the arrangement. Furthermore, a gap in the arrangement that has arisen due to a display being cleared may be closed by dynamically moving the remaining supervisory information. For example, if a light disappears, the lights that have appeared thereafter move back one field more. This means that, depending on the number of indicator lights, the position may vary between KL1 and KL9. The location and the implementation are not specific and have been depicted here only as an example. In the exemplary embodiment in FIG. 3, the method 10 comprises building up the displayed supervisory information/symbols over the adjacent display fields in succession in a direction predefined by the arrangement of the display fields. The arrangement may be provided along a wide variety of geometries. By way of example, directional profiles that are based on other displays in the field of view are also conceivable.

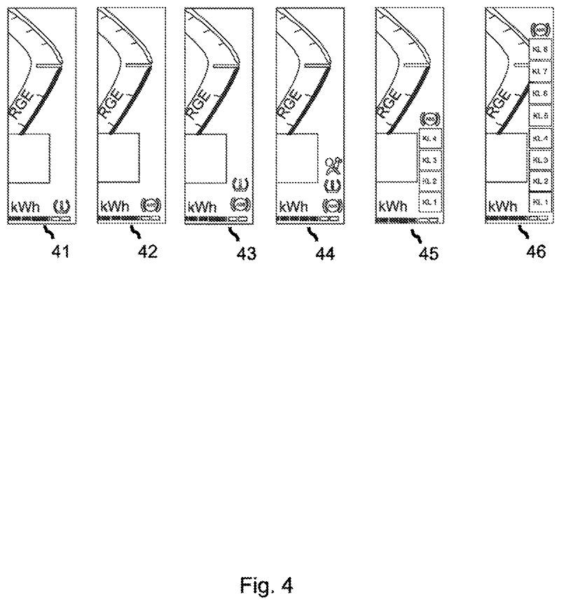

FIG. 4 shows a schematic illustration relating to the buildup of a display of multiple items of supervisory information in one exemplary embodiment. As FIG. 4 shows, the buildup runs from left to right. The displayed supervisory information is built up over the adjacent display fields in succession in a direction predefined by the arrangement of the display fields. The arrangement here is again a column that is built up from the bottom upwards. The left-hand side of FIG. 4 first shows a situation 41 in which only a tire pressure warning is displayed in the column, at the bottom, and no other indicator light is activated. The situation 42 similarly illustrates a display of an ABS (anti-lock braking system) warning without further indicator lights at the bottom in the column. In the illustration 43, FIG. 4 shows a situation in which an ABS warning appears first, followed by a tire pressure warning, which is then displayed in the next display field. The situation 44 builds on the situation 43 in that an airbag warning light is also additionally activated and is then displayed a further position higher. The most recent indicator light in this exemplary embodiment is always displayed at the top position in the column of display fields. The situation 45 shows that the ABS warning is displayed at position KL5 after there have already been 4 other indicator lights at the positions KL1-KL4. The situation 46 shows the display when the ABS warning signal is activated as the ninth indicator light and eight other indicator lights are already activated at the positions KL1-KL8.

By virtue of the described arrangement, exemplary embodiments contribute to improved clarity on the dashboard or in the field of view of the driver. This also makes it possible to achieve an improved understanding of associated text-based fault messages (Check Controls) and corresponding indicator lights, since these are able to be placed at locations that are close to one another for the entire spectrum of fault indicator lights. Furthermore, a dynamic arrangement such as this is space-saving and may contribute to reducing distractions (due to the consistent region the display). A comprehensible chronology of the occurrence of faults is also shown, such that it is possible to derive a causality chain.

Further exemplary embodiments are computer programs for performing one of the methods described herein when the computer program runs on a computer, a processor, or a programmable hardware component. Depending on the specific implementation requirements, some exemplary embodiments may be implemented in hardware or in software. The implementation may be carried out using a digital storage medium, for example a floppy disk, a DVD, a Blu-Ray disk, a CD, a ROM, a PROM, an EPROM, an EEPROM or a flash memory, a hard disk or another magnetic or optical memory storing electronically readable control signals that interact, or able to are interact, with a programmable hardware component such that the respective method is performed.

A programmable hardware component may be formed by a processor, a computer processor (CPU=central processing unit), a graphics processor (GPU=graphics processing unit), a computer, a computer system, an application-specific integrated circuit (ASIC), an integrated circuit (IC), a system-on-chip (SOC), a programmable logic element or a field-programmable gate array (FPGA) having a microprocessor.

The digital storage medium may therefore be machine-readable or computer-readable. Some exemplary embodiments thus comprise a data carrier containing electronically readable control signals that are capable of interacting with a programmable computer system or a programmable hardware component such that one of the methods described herein is performed. One exemplary embodiment is thus a data carrier (or a digital storage medium or a computer-readable medium) on which the program for performing one of the methods described herein is recorded.

Generally speaking, exemplary embodiments may be implemented as a program, firmware, computer program or computer program product containing a program code or as data, wherein the program code or the data have the effect of performing one of the methods when the program runs on a processor or a programmable hardware component. The program code or the data may for example also be stored on a machine-readable carrier or data carrier. The program code or the data may be present inter alia as source code, machine code or byte code and as other intermediate code.

The exemplary embodiments described above represent only an overview of the principles of the present disclosure. It goes without saying that modifications and variations to the arrangements and details described herein will be apparent to others skilled in the art. The intention is therefore for the invention to be restricted only by the scope of protection of the claims hereinbelow, and not by the specific details that have been presented herein with reference to the description and the explanation of the exemplary embodiments.

### LIST OF REFERENCE SIGNS

10 method for displaying supervisory information in the field of view of a driver of a vehicle
12 displaying two or more items of supervisory information in an arrangement of adjacent display fields
14 displaying a temporal relationship between the occurrences of the two or more items of supervisory information via positions of the two or more items of supervisory information within the arrangement
20 device for displaying supervisory information in the field of view of a driver of a vehicle
22 one or more interfaces
24 control unit/control module
41-46 display situations
200 vehicle
KL1-KL9 display fields

1.-11. (canceled)

12. A method for displaying supervisory information in the field of view of a driver of a vehicle, comprising:
displaying two or more items of supervisory information in an arrangement of adjacent display fields; and
displaying a temporal relationship between the occurrences of the two or more items of supervisory information via positions of the two or more items of supervisory information within the arrangement.

13. The method as claimed in claim 12, further comprising displaying a newest item of supervisory information at one end of the arrangement and displaying an oldest item of supervisory information at another end of the arrangement.

14. The method as claimed in claim 13, further comprising displaying the oldest item of supervisory information or the newest item of supervisory information from the two or more items of supervisory information always at the same absolute position in the field of view of the driver.

15. The method as claimed in claim 14, wherein the arrangement of adjacent display fields are arranged in a column.

16. The method as claimed in claim 14, further comprising clearing a display of supervisory information that is no longer relevant from the arrangement.

17. The method as claimed in claim 16, comprising closing a gap in the arrangement that has arisen due to the display being cleared by dynamically moving remaining supervisory information.

18. The method as claimed in claim 13, further comprising clearing a display of supervisory information that is no longer relevant from the arrangement.

19. The method as claimed in claim 18, comprising closing a gap in the arrangement that has arisen due to the display being cleared by dynamically moving remaining supervisory information.

20. The method as claimed in claim 12, comprising building up the displayed supervisory information over the adjacent display fields in succession in a direction predefined by the arrangement of the display fields.

21. The method as claimed in claim 12, wherein displaying the two or more items of supervisory information in the arrangement of adjacent display fields comprises displaying at least one of the two or more items of supervisory information as a representative graphic symbol.

22. The method as claimed in claim 21, further comprising displaying a newest item of supervisory information at one end of the arrangement and displaying an oldest item of supervisory information at another end of the arrangement.

23. The method as claimed in claim 22, further comprising clearing a display of supervisory information that is no longer relevant from the arrangement.

24. The method as claimed in claim 23, comprising closing a gap in the arrangement that has arisen due to the display being cleared by dynamically moving remaining supervisory information.

25. The method as claimed in claim 24, wherein the supervisory information comprises one or more elements from the group comprising a tire pressure warning signal, a warning signal from an anti-lock braking system, an airbag warning signal, an engine warning signal, a steering warning signal, a proximity warning signal, a performance warning signal, a battery warning signal and a handbrake warning signal.

26. The method as claimed in claim 12, wherein the supervisory information comprises one or more elements from the group comprising a tire pressure warning signal, a warning signal from an anti-lock braking system, an airbag warning signal, an engine warning signal, a steering warning signal, a proximity warning signal, a performance warning signal, a battery warning signal and a handbrake warning signal.

27. A non-transitory storage medium storing a computer program, wherein the computer program performs the method as claimed in claim 12 when the computer program run on a computer, a processor or a programmable hardware component.

28. A device for a vehicle, having a control unit that is configured to perform the method of claim 12.

29. A vehicle having a device as claimed in claim 28.
